(19) United States
(12) Patent Application Publication
(10) Pub. No.: US 2007/0256796 A1
(43) Pub. Date: Nov. 8, 2007

(54) Modified awning roll bar

(76) Inventor: Donald S. Wedin, Sequim, WA (US)

Correspondence Address: DONALD S. WEDIN, 32 MARJORY LN, SEQUIM, WA, 98382, US

(21) Appl. No.: 11/429,486

(22) Filed: May 5, 2006

(51) Int. Cl. E06B 9/08

(52) U.S. Cl. 160/121.1

(57) ABSTRACT

A fabric roll bar having the fabric attached to it at the mid-point of the sheet. When the roll bar is rotated, it results in the fabric on each side of the roll bar moving in equal but opposite directions thus facilitating the fabric of two shelters simultaneously.

### BACKGROUND

1. Field of Invention

This invention relates to fabric roll bars, specifically to an improved fabric roll bar.

2. Discussion of Prior Art

A computer patent search and a Thomas.com search failed to show prior art. Motor home supply catalogues, motor home awnings, tarpaulin and canvas supply houses also failed to show prior art. Related uses for canvas roll bars, for greenhouses and truck cargo covers and such, failed to reveal prior art

Agriculture products have always been subject to damage from the elements, rain, sun and wind; any shelter to lessen the damage is welcome. Time is important, getting products from the field and under shelter before the rains come. The best shelters are usually buildings, but they have a down side in that they may be far from the field and costly to build and maintain Temporary shelters of canvas or plastic have become popular. Baled stacks of hay represent one example of an agricultural product stored under plastic tarpaulins. Unfortunately, sheets of tarpaulin are difficult to manipulate. Usually, they are draped over the stacks, tied down and secured at the base. Although agricultural tarpaulins are relatively inexpensive they are difficult for one person to handle and sometimes impossible if it is windy. Under the best of conditions, this type of shelter is a challenge for one person to deploy.

Motor homes employ awnings for shade and shelter, usually, these awnings are attached to the sides of a vehicle or building furnishing shelter for the occupants but little for the vehicle or building, itself.

The fabrics of conventional awnings are fastened to roll bars at one end of a fabric sheet limiting its ability to serve but one shelter.

The length and size of awnings are restricted by the tendency of roll bars to bend when attempting to create a taut canvas; this is required to prevent the pooling of rainwater. Being heavy, pooled water has the potential for causing structural damage as well as being an annoyance.

### OBJECTS AND ADVANTAGES

Accordingly, several objects and advantages of my roll bar are: It facilitates the fabrics of two shelters, simultaneously, one on each side of the roll bar, it may be placed atop an embodiment, making it more flexible in location.

Conventional awnings are functional only when located on the side of an embodiment, a vehicle or building, which limits their value when shelter is required on top. Conventional awning roll bars can serve only one shelter; the configuration of this roll bar permits it to service two. This is possible because the fabric on this roll bar is attached to the roll bar at the midpoint of a sheet rather than at the end. This results in the fabric—on opposite sides of the roll bar—moving in equal but opposite directions. Thus, by joining two sheets of fabric, on opposing sides of, the roll bar, it more than doubles the area that may be serviced; an awning on each side of an embodiment as well as shelter for the embodiment itself.

Perhaps simple oversight accounts for awning fabrics to have been fastened at the end of sheets and not at midpoints but, by doing so, it makes it possible to facilitate the fabrics of two awnings.

A further object and advantage: because the two shelter fabrics are joined opposite each other, at a common roll bar, it overcomes the problem of slackness. With a single roll bar, a taut fabric is difficult to maintain because roll bars tend to bend under stress; the longer the bar the greater tendency to do so, limiting the size of the shelter.

In the configuration of the roll bar described herein, tension is not a problem because the tension placed on one fabric is overcome by an equal and opposite tension upon the other, resulting in both becoming taut. No significant lateral stress is placed on the roll bar, so it remains in position, relatively undisturbed.

A further object and advantage is the flexibility of location. Not being restricted to the sides of buildings or vehicles, this roll bar permits positioning atop embodiments. With the roll bar on top, the fabrics may be unfurled over the sides, resulting in the fabrics becoming available for two awnings with shade and shelter for the vehicle as well. Placed atop an embodiment, such as a stack of baled hay, this roll bar needs no bearings upon which to roll; it rolls and un-rolls upon itself and the embodiment supporting it.

### Other Objects and Advantages

Wind damage to fabric shelters is always a consideration; replacing fabric is expensive. The simplicity of this roll bar permits easy replacement and the use of inexpensive materials. Agricultural tarpaulins and disposable plastic sheeting work well—things used by farmers for horizontal plastic silos and round hay bales.

Further objects and advantages will become apparent from a consideration of the ensuing description and drawings.

### SUMMARY

In accordance with the invention, my roll bar overcomes some of the limitations of current roll bars because it functions differently. The fabric is attached to a roll bars at mid-point (or mid-points of a sheet) (s) rather than at the end, thus making it possible to deploy larger shelters with greater flexibility in location.

### DRAWINGS

FIG. 1 is a top view of the preferred embodiment (a stack of baled hay), depicting the roll bar with fabric unrolled over the side.

FIG. 2 depicts the direction of fabric in response to rotation of the roll bar.

FIG. 3 is a perspective view of the parts in the combined roll bar.

FIG. 4 shows the assembly of parts linking the roll bar to a power source.

FIG. 5 shows the power source in relationship to roll bar

FIG. 6 is a top view of a second preferred embodiment, a motor home, with the fabric extending over the embodiment as well as two awnings. (No further details offered)

### LIST OF REFERENCE NUMERALS

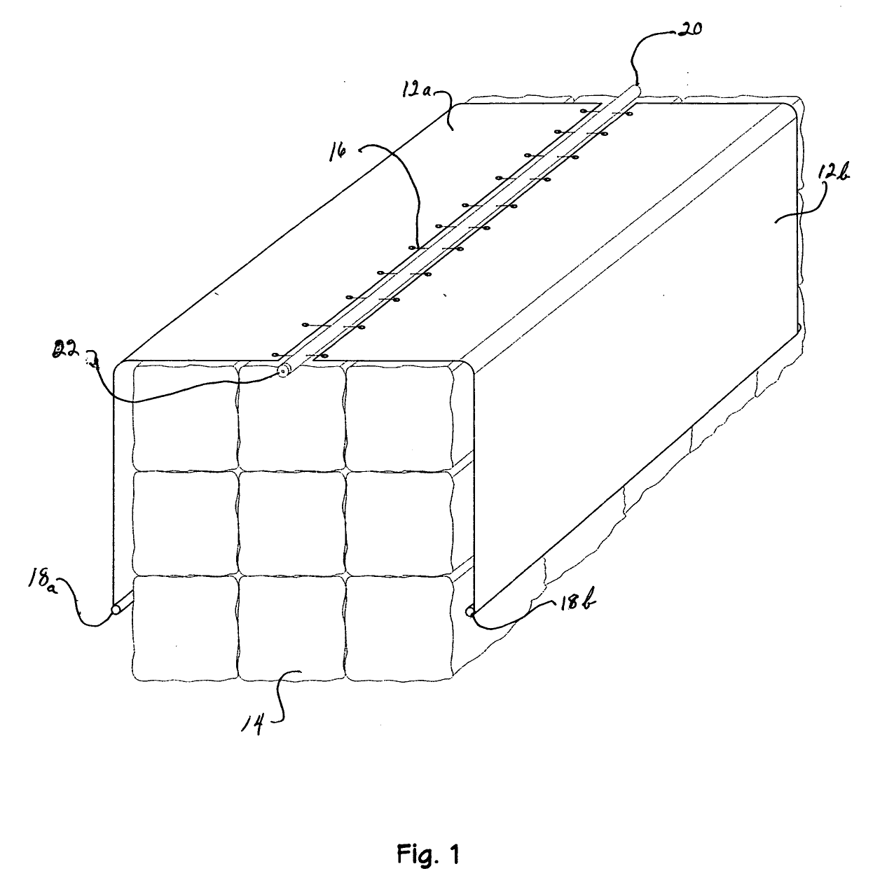

FIG. 1

14 first preferred embodiment, a stack of baled hay
12a fabric
12b fabric
16 wire rope connecting fabrics, 12a and 12b
18a semi-flexible tube at bottom of fabric 12a
18b semi-flexible tube at bottom of fabric 12b
20 distal end of roll bar
22 pipe-threaded proximal end of roll bar

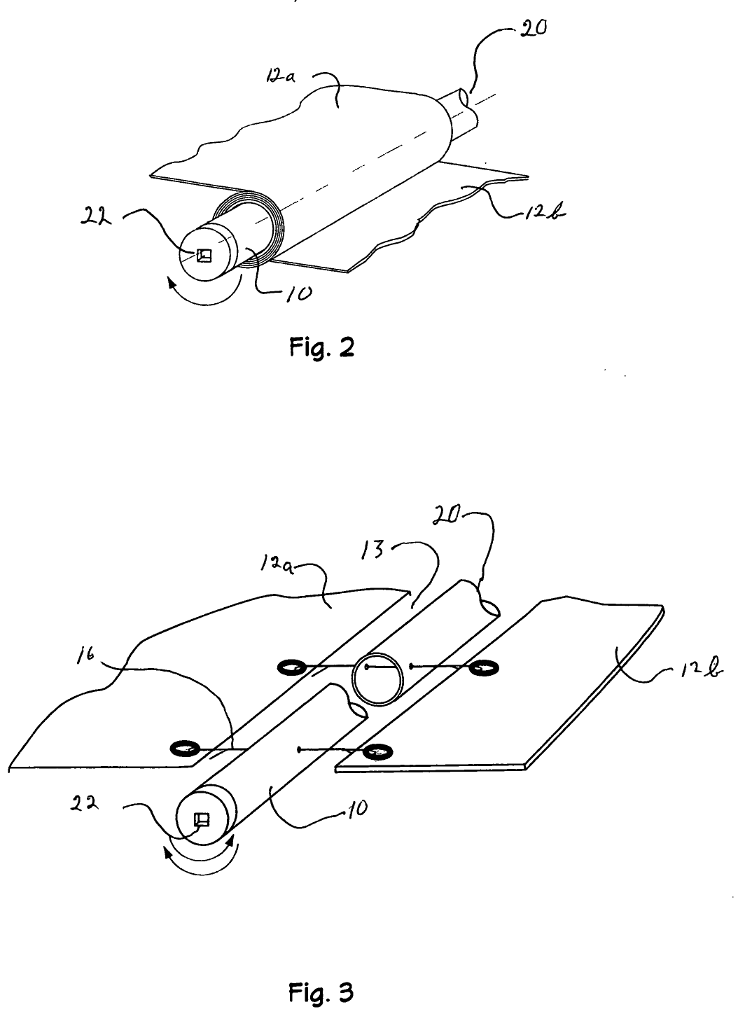

FIG. 2
10 roll bar, direction of rotation
12a fabric
12b fabric
20 distal end of roll bar
22 pipe-threaded proximal end of roll bar
   FIG. 3 10 roll bar
12a fabric on left side of preferred embodiment
12b fabric on right side of preferred embodiment
13 optimal space
16 wire rope
   FIG. 3 20 distal end of roll bar
22 pipe-threaded proximal end of roll bar

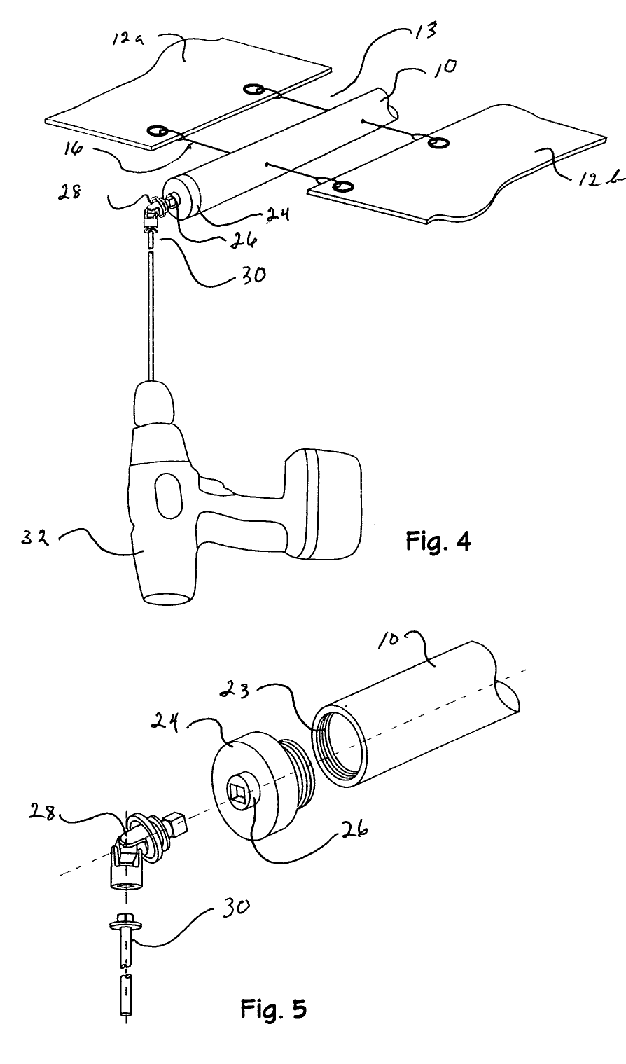

FIG. 4
10 roll bar
23 interior end of pipe-threaded proximal end of roll bar
24 pipe-threaded metal adapter plug
26 welded-on socket adapter
28 socket wrench universal joint
30 socket wrench extension rod (s)

FIG. 5
10 roll bar
12a fabric
12b fabric
16 wire rope
28 universal joint
30 extension shaft
32 power means

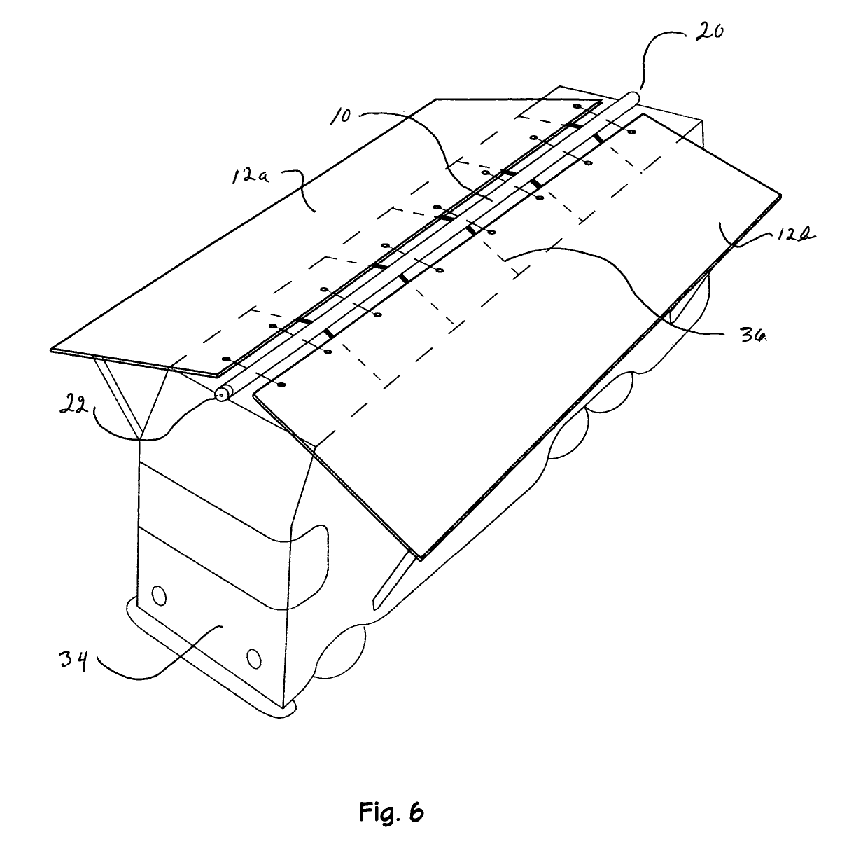

FIG. 6
34 second preferred embodiment, a motor home
36 ribbed structure atop embodiment
10 roll bar
12a and 12b awning fabrics
20 distal end of roll bar
22 proximal end of roll bar

### DESCRIPTION OF INVENTION

### Preferred Embodiment

FIG. 1 shows a top view of preferred embodiment 14, (a stack of baled hay) supporting roll bar 10 with fabrics 12a and 12b draped over their respective sides. It shows semi-flexible plastic tubing 18 lashed to the bottoms of fabrics 12a and 12b providing structural strength.

FIG. 2 depicts the two fabrics, 12a and 12b, rolled up on roll bar 10; arrows indicating their response to rotation.

FIG. 3 shows wire rope 16 passing through previously drilled holes in roll bar 10 connecting fabrics 12a and 12b. An optional space 13 is indicated permitting ventilation if desired by adjusting the lengths of the connecting wire rope.

FIG. 4 shows the power linkage between proximal end 22 of roll bar 10 and power source 32. Socket wrench equipment is used. It shows pipe-threaded, proximal end of roll bar 10 mating with pipe-threaded metal plug 24. Socket wrench socket 26 is welded to metal plug 24 enabling it to engage socket wrench universal joint 28. Socket wrench extension shafts 30 connect socket wrench universal joint 28 to power source 32.

FIG. 5 shows the extended linkage between the proximal end 22 of roll bar 10 and the power source, 32. It shows the interior threads 23 of proximal end of roll bar 10 mating with the metal pipe-threaded metal plug 24.

FIG. 6 shows top view of the second preferred embodiment, motor home 34. It shows ribbed structure 38 secured atop the motor home supporting roll bar 10 and the sheets of awning 12a and 12b extended as awnings. (No further details offered).

### Operation of Invention

Roll bar 10, in combination with fabrics 12a and 12b, is assembled, along with support tubes 18a and 18b on a flat surface. It is rolled up as an entity prior to being placed atop embodiment 14.

The assembled roll bar 10 is unfurled over the embodiment in the following way: The support tubes, which are lashed at the bottom of each fabric, are grasped in alternate fashion, and pulled over its respective side. When each side of the shelter is properly draped, weights or anchors are suspended from the support tubes and the shared tension of the opposing sheets of fabric hold the emptied roll bar in place. If the optional ventilation space shown in FIG. 4 is not desired, a turn or two of the roll bar will close it preventing water or wind from entering. In this application, the roll bar needs no bearings upon which to roll; it rotates upon itself and on the object being covered (the hay stack, in this case). It is held in place by the opposing forces of the two fabrics, with little lateral stress being placed on the roll bar itself.

### OTHER USES: EMBODIMENTS AND RAMIFICATIONS

Motor homes are a second embodiment that would benefit from this configuration of roll bar and fabric. Motor homes have many obstructions on their roofs; air conditioners, antennas, vents, etc. must be located here making is especially difficult to cover with tarpaulins, especially for one person.

One could overcome this problem with the construction of a light-weight-framework of tubing fashioned to clear the obstructions. Secured atop the motor home, it would furnish ribbed support for the roll bar. It would facilitate the fabric awnings for two awnings, one on each side the motor home; in doing so, provide shade and shelter for the vehicle as well. (This would be much appreciated when the heat of the sun is intense.)

When the vacationing period is over the fabrics with their support tubes, would be draped over the side and secured from the wind, providing portable and inexpensive winter storage.

Truckers would welcome this concept of providing a rapidly deployable cover for open-bed trucks in event of bad weather. Greenhouse people would find this application useful, providing inexpensive and, perhaps, disposable greenhouse roofing. The roll bar, being of variable lengths and with choices of fabric could meet the need of hobby farmers for temporary roofing.

Commercially, as a manufactured product, the fabric, itself, would be financially viable, even without the roll bar and power facility. For example, if one were to fold a suitable fabric in the middle, and fasten it at this point, in the middle, upon itself, or to a disposable paper tube (like the tubing inside rolls of carpeting) one would have, essentially, the rolled-up roll bar described in this patent application. It would be much easier to deploy, in this configuration, than the folded-up plastic currently being sold.

If it were of disposable material, such as that used by farmers for plastic horizontal silos and round hay bales, there would be no need for a roll up device.

My present choice of fabric is agriculture tarpaulin with grommets already installed. My present choice to power the roll bar is a half-inch battery powered drill—a low speed, high torque drill—one having counter-torque grips at the side.

Being easily attached and detached, it is readily available for other tasks as well. In event of power failure, a socket wrench “speed crank” or ratchet may be used for back up.

Although my present choice for attachment of the two fabrics to the roll bar is with wire rope extended through the roll bar, there are many other options: clamps, screws extending through metal strips and the fabric to name a few.

While my roll bar contains many specificities, these should not be construed as limitations on the scope of the invention, but rather as an exemplification of one preferred embodiment thereof. Many other variations are possible.

Accordingly, the scope of the invention should be determined not by the embodiment (s) illustrated, but by the appended claims and their legal equivalents, rather than by the examples given.

I claim:

1. a fabric roll bar comprising,
a. an elongated tube in combination with fabric,
b. a power means to rotate the tube.

2. the fabric of claim 1 further comprised of,
a. two sheets of said fabric joined together,
b. said joining at mid-point to said tube,
c. said joining wire rope,
d. said joining adjustably spaced,
e. said sheets a variety of fabrics,
f. said tube a variety of tubes.

3. the fabric of claim 1 further comprised of,
a. semi-flexible tubing lashed to grommets at the base of the fabric.

4. the elongated tube of claim 1 further comprised of,
a. proximal end of said tube pipe-threaded,
b. socket-adapted pipe-threaded metal plug.

5. the power means of claim 1 further comprising,
a. socket universal joint,
b. socket extension rod (s),
c. high-torque low-speed power means,
d. said power means portable, whereby, in concert, empowers said fabric roll bar.
